(19) United States
(12) Patent Application Publication
(10) Pub. No.: US 2005/0281213 A1
(43) Pub. Date: Dec. 22, 2005

(54) Wireless network bridge with remote indicator circuit

(76) Inventor: Reuben Dohn, Phoenix, AZ (US)

Correspondence Address: ETHERTON LAW GROUP, LLC, 5555 E. VAN BUREN STREET, SUITE 100, PHOENIX, AZ, 85008, US

(21) Appl. No.: 11/156,199

(22) Filed: Jun. 17, 2005

Related U.S. Application Data
(60) Provisional application No. 60/580,563, filed on Jun. 17, 2004.

(51) Int. Cl. H04B 7/00

(52) U.S. Cl. 370/310

(57) ABSTRACT

A wireless network bridge with a signal indicator for use in a vehicle is disclosed. The network bridge comprises three components: an antenna assembly to receive and transmit signals to and from an internet access point; a hub to transmit data and power; and a signal indicator to provide a visual or audible indication of the strength of an available signal.

### CROSS-REFERENCE TO RELATED APPLICATIONS

This application claims the benefit of co-pending provisional application No. 60/580,563 filed on Jun. 17, 2004.

### FIELD OF INVENTION

This invention relates to a system for obtaining wireless, high-speed internet access in a vehicle such as a car, truck, recreational vehicle (RV), or boat. This invention particularly relates to a system and method for detecting the presence of a wireless network signal while in a vehicle and transmitting data over the network using that signal also while in the vehicle.

### BACKGROUND

Internet access can be obtained by using a traditional dial-up connection using a modem connected to a phone line or by using high-speed connections such as digital subscriber line (DSL) or cable modems. Until recently, these connections required that the user's computer be physically connected to the internet source by a cable. However, connections have been developed that allow a user to access the internet wirelessly. For example, properly equipped computers, PDA's, cell phones and other user devices can access the internet wirelessly using Bluetooth or other known wireless technologies.

A high-speed, wireless network requires two devices: an internet access device that is physically connected to the internet source that can transmit and receive signals wirelessly, typically referred to as an access point, and a remote user device that can transmit and receive signals wirelessly, such as a computer. A standard has been created for transmitting the data wirelessly that permits interoperability of all devices that use the standard. The standard is referred to as “Wi-Fi,” and products certified as Wi-Fi are interoperable with each other even if they are from different manufacturers. For example, a user with a Wi-Fi product can use any brand of access point with any other brand of computer or cell phone that is built to the Wi-Fi standard. Examples of Wi-Fi standards include 802.11b, 802.11g, and 802.11n, each operating at different data speeds.

An access point comprises a radio and antenna for broadcasting a signal carrying internet data received from the internet source and receiving a signal carrying internet data from one or more remote computers that are Wi-Fi equipped. Similarly, to communicate with the access point, the user's remote computer must have a radio and antenna for receiving and transmitting the signal. One piece of equipment used to connect two wireless systems is commonly referred to as a wireless network bridge. A remote computer equipped with a wireless network bridge can transmit and receive data over the internet just as a computer that is physically attached to the internet can, as long as the remote computer is within a specific geographic range of an access point.

This area around an access point where Wi-Fi-equipped computers can receive and transmit data to and from the access point is referred to as a “hot spot.” Due to the popularity of Wi-Fi, businesses offer “hot spots” to potential customers to drive business. Currently, some of the most popular places for hot spots include restaurants, cafes, coffee shops, campsites, marinas, libraries, and airports.

Unfortunately, the geographical range of hot spots is limited. In fact, most internet users cannot stray more than 30-150 feet from an access point and maintain connection to the internet. One of the main reasons for the limited reach of hot spots is a phenomenon known as “multi-pathing.” Multi-pathing (similar to an echo) occurs when transmission signal within a hot spot bounces off interior walls. This multi-pathing reduces the strength of the signal sent from an access point dramatically. Also, signal strength decreases with distance. These limits on the geographical reach of Wi-Fi limit its usefulness and in some cases, preclude its use in applications where Wi-Fi would be the most desirable.

Specifically, high-speed, wireless internet access is not currently available in any practical form for use in cars, trucks, boats, recreational vehicles (RVs) or other vehicles. If high-speed, wireless internet access could be obtained by users in vehicles, the users could drive through various hot spots and “surf” the web while in these hot spots. In this scenario, internet users could use their computers while traveling in a taxi or limousine. Users could also obtain high-speed, wireless internet access while in an RV that was moving or parked at a campsite. Boaters could also connect to the internet wirelessly by tapping into hot spots while docked at distance slips at marinas. In areas with numerous hot spots (such as large cities) a user could maintain internet access while moving throughout the city.

This ideal situation is not currently viable because no systems are known that enable computers located within vehicles to access hot spots beyond the very limited geographical ranges. The currently attainable range of 30-150 feet per hot spot simply is not big enough to enable users in moving vehicles to efficiently connect to the internet wirelessly.

Therefore, it is an object of the present invention to provide a system for providing internet access to vehicles. It is also an object of the present invention to provide a system that monitors the strength of various hot spots and alerts the user to the presence of a hot spot and provides immediate high-speed, wireless internet access upon the detection of a hot spot.

### SUMMARY OF THE INVENTION

The present invention is a system that provides access to high-speed, wireless internet access for vehicles such as cars, trucks, RVs, trains, planes, and boats. The system comprises an antenna assembly to receive and transmit signals to and from an internet access point; a hub to transmit data and power; and a signal indicator to provide a visual or audible indication of the strength of an available signal. The antenna assembly is mounted on the exterior of the vehicle and is connected to the hub that passes the data it receives to a computer over a network connection. The system also comprises a signal processor that takes the antenna signal, modulates it into a data stream (preferably variable frequency) and delivers it to a separate signal indicator. The signal indicator measures the strength of the Wi-Fi signal received from the antenna and indicates to the user the availability and strength of a particular hot spot. The user can immediately identify a hot spot and automatically wirelessly connect his computer to it while in a vehicle. The system is powered by a power source, preferably the vehicle's battery.

### BRIEF DESCRIPTION OF THE DRAWINGS

FIG. 1 is a schematic view of a vehicle with the system installed;

FIG. 2 is a block diagram of the functional components of the wireless network bridge;

FIG. 3 is a block diagram of the functional components of the antenna assembly;

FIG. 4 is a block diagram of the functional components of the hub;

FIG. 5 is a front view of the signal indicator; and

FIG. 6 is block diagram of the functional components of the signal indicator.

### DETAILED DESCRIPTION OF THE INVENTION

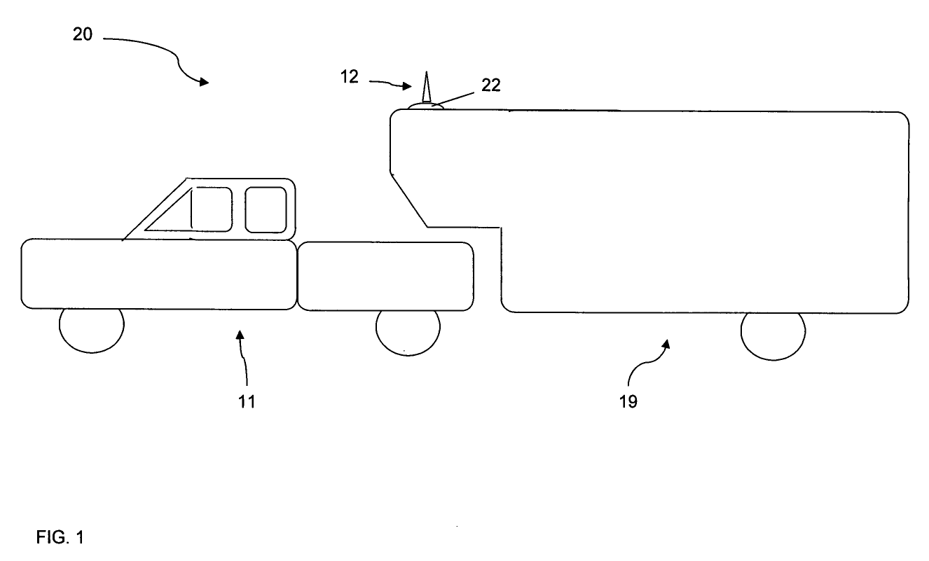

The present invention enables users to obtain high-speed internet access while in a vehicle 20 by detecting the presence of a wireless signal and transmitting and receiving internet data over that signal. The vehicle 20 includes a portion used by the driver, referred to herein as a cab 11, and a portion where a computer is used, referred to herein as the computing area 19. See FIG. 1. For safety reasons, preferably the cab 11 is not the same as the computing area 19 but it is recognized that they may be one in the same.

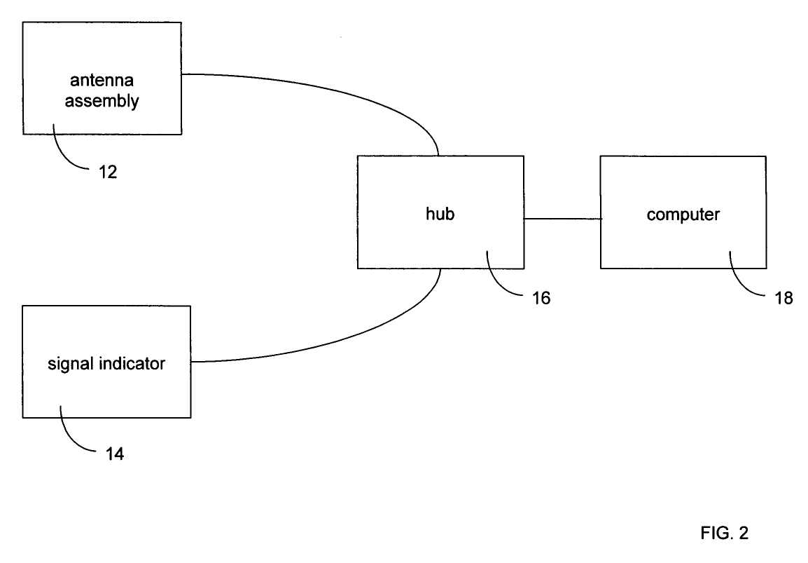

The present system comprises three components as shown in FIGS. 2-5: an antenna assembly 12, a hub 16, and a signal indicator 14, which function together to provide internet access to a computer 18. In the preferred embodiment, antenna assembly 12 is in the line of sight of an access point. Ideally, antenna assembly 12 is mounted on the exterior of vehicle 20, preferably on the roof and in or near the computing areal9. Mounting antenna assembly 12 on the exterior of vehicle 20 enables the antenna 24 to receive signals at relatively long distances from access points because it helps eliminate multi-pathing.

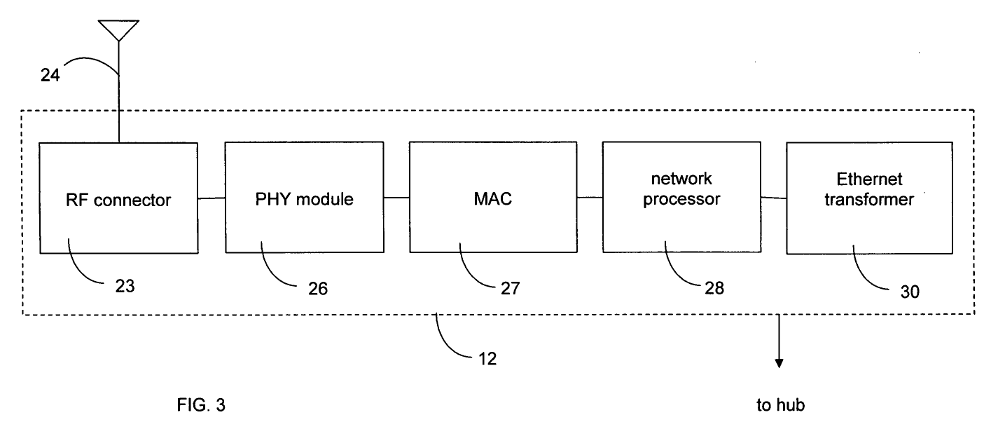

The antenna assembly comprises a housing 22, which is secured to vehicle 20. As shown in FIG. 3, antenna assembly 12 comprises an antenna 24, an RF connector 23, a physical layer (PHY) module 26, a media access controller (MAC) layer 27, a wireless network processor 28, and a network connection, preferably an Ethernet transformer 30. The antenna 24 can be any type of omni-directional antenna, but preferably is a high-gain, dipole antenna that has been adapted to receive internet transmissions of the desired Wi-Fi protocol by known methods in the art. Such a high gain, omni-directional antenna enables signal reception from access points at distances of over 2000 feet.

Antenna 24 receives a signal from an access point (not shown) and the signal is modulated into Ethernet protocol for transmission to hub 16. Antenna 24 passes the data contained in the signal to PHY module 26 through the RF connector 23, also known as a radio. PHY module 26 is in operative communication with MAC layer 27. MAC layer 27 has a digital interface with the wireless network processor 28 on a PCMCIA bus protocol. In the preferred embodiment, PHY module 26 is a WL1141 module manufactured by Agere Systems of Allentown, Pa. and MAC layer 27 is preferably a WL60401 MAC layer also manufactured by Agere Systems.

Wireless network processor 28 processes the wireless data received and transmits it to Ethernet transformer 30 then to hub 16 for delivery to computer 18. Wireless network processor 28 is preferably an IP2022™ processor manufactured by Ubicom, Inc. of Mountain View, Calif. In the preferred embodiment, Ethernet transformer 30 is a magnetic Ethernet device such as HN1623.

While discreet devices are described, the components of the antenna assembly may be integrated. For example, in the preferred embodiment, wireless network processor 28 is a microprocessor with built-in 10Base-T Ethernet MAC layer and PHY modules.

In addition to Ethernet data delivered to the hub 16, the antenna assembly 12 also transmits the access point signal strength data to the signal indicator 14 via the hub 16 to indicate the strength of the data, as described in more detail below. The antenna assembly 12 is connected to the hub 16 preferably using an RJ-45 jack located on housing 22.

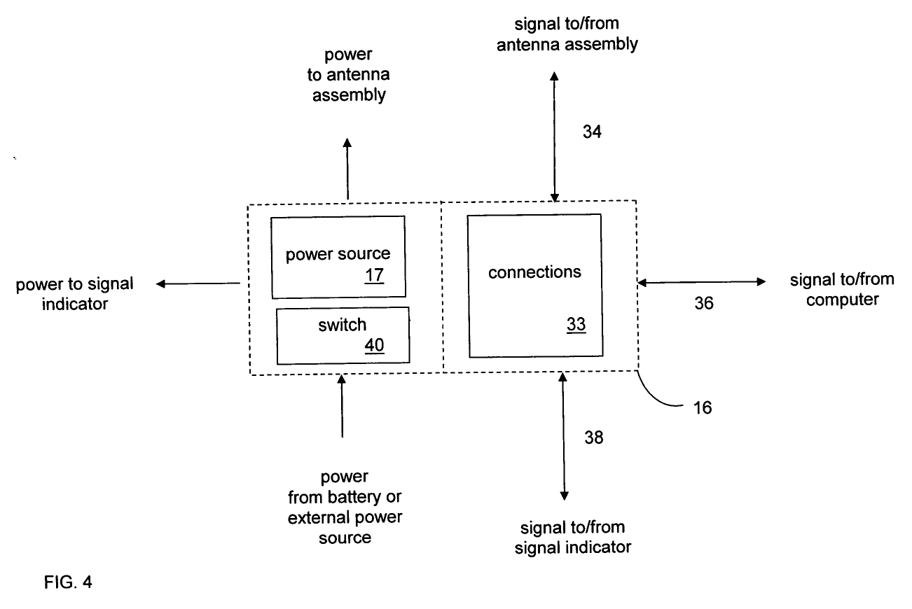

The hub 16 transmits power and data. For power, hub 16 delivers power to antenna assembly 12 and signal indicator 14 using a power source 17. See FIG. 4. The power is preferably from a connection to the vehicle's battery, either by hardwire or by being plugged into a traditional power outlet located in the vehicle, such as a cigarette lighter outlet. Because power source 17 draws power from vehicle 20 and not computer 18, the wireless network bridge of the present invention can utilize more powerful components that otherwise could not be used if power source 17 drew power from computer 18. A switch 40 enables the user to control the power delivery to and from hub 16.

Hub 16 transmits data using connections 33. In the preferred embodiment, the hub 16 comprises three connectors 34, 36, and 38, which are preferably RJ-style jacks. Data from antenna assembly 12 enters hub 16 through connector 34. This data is then sent through connector 36 to computer 18 and through connector 38 to signal indicator 14. To maximize data integrity, data transmitted through hub 16 is preferably transmitted through wires, as known in the art, but wireless connections may also be used.

Signal indicator 14 provides indication of the strength of the wireless data signal received by antenna assembly 12 and thereby provides the user with an indication of the availability and strength of a particular hot spot. The indication may be visible, audible, or both. In the preferred embodiment, signal indicator 14 is attached to vehicle 20 and is preferably located within the dashboard, therefore resembling a normal gauge. Alternatively, signal indicator 14 can be installed in the cab or computing area, such as the interior of an RV or the interior of a boat. In other embodiments, signal indicator 14 could be a separate device from vehicle 20, and permanently or removably attached to vehicle 20.

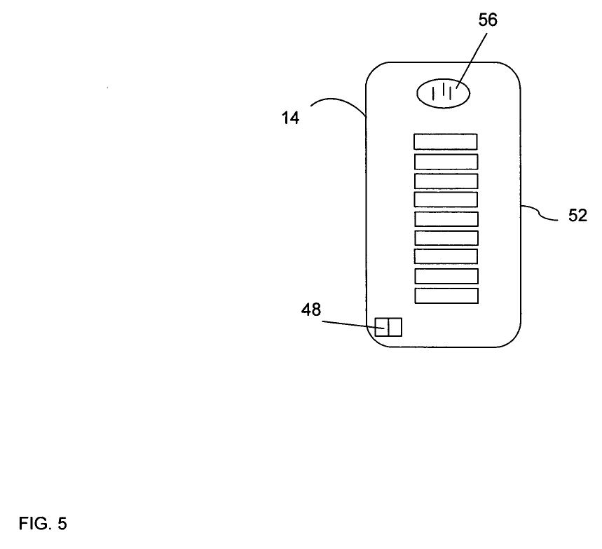

In this preferred embodiment, the visual gauge is a light emitting diode (LED) device with a light emitting diode driver 50 and several LEDs 52 that illuminate depending on the strength of the hot spot. See FIG. 5. For example, if the user positioned vehicle 20 so that vehicle 20 was in the area of the hot spot with a stronger signal strength, all of LEDs 52 would be illuminated. If the user moved the vehicle to an area to the hot spot with weaker signal strength, fewer of the LEDs 52 would be illuminated. If the user positioned the vehicle completely out of a hot spot, no LEDs 52 would be illuminated.

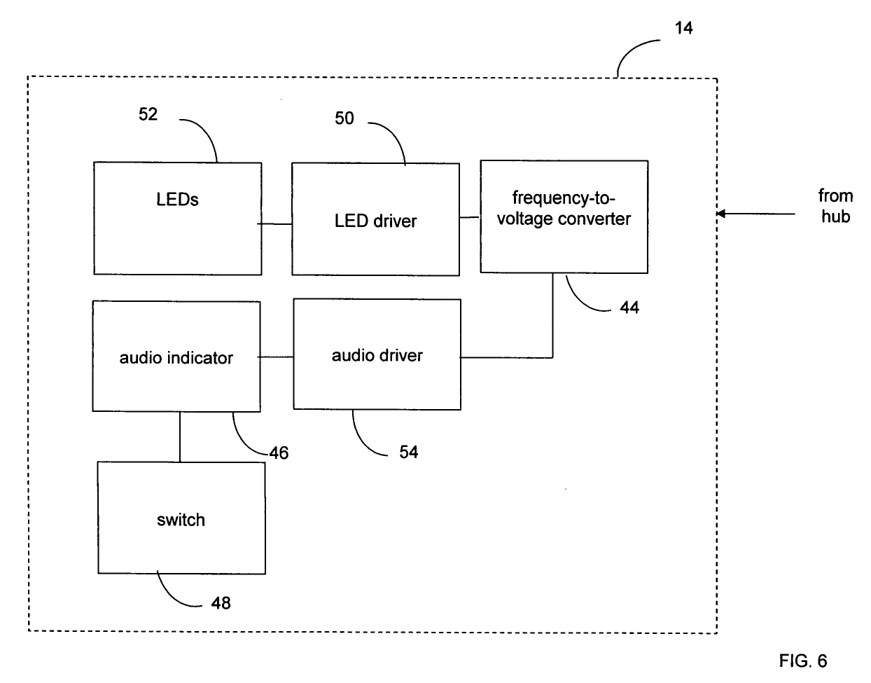

The audible gauge can be any type of known audible alarm, such as a buzzer, bell, tone or voice recording. In the preferred embodiment, the audible gauge comprises an audio driver 54 connected to an audio indicator 46, preferably a speaker 56. See FIG. 6. Speaker 56 emits noise when vehicle 20 has entered the range of a hot spot. Audible gauge can be adjusted to emit a louder sound if vehicle 20 is receiving a particularly strong signal from an access point within a hot spot. A switch 48 enables the user to adjust signal indicator 14 to utilize the visual gauge or the audible gauge, or both.

Signal indicator 14 determines the strength of the signal detected by antenna assembly 12 by monitoring signal strength data produced by antenna assembly 12 and sent to the signal indicator from hub 16. Specifically, signal indicator 14 has a frequency-to-voltage converter 44 that converts the frequency-modulated data produced by antenna assembly 12 and uses it to drive the indicators. In this preferred embodiment, the frequency-to-voltage converter is a device such as LM2917 frequency-to-voltage converter manufactured by the National Semiconductor, Inc. of Santa Barbara, Calif.

Signal indicator 14 is preferably hard-wired by traditional means to hub 16. In an alternative embodiment, signal indicator 14 could communicate with hub 16 wirelessly. Signal indicator 14 can transmit signals to and from hub 16 on numerous radio frequencies, examples of which are 315, 418, 433, or 916 MHz custom modulated frequency or the 2.4 GHz frequency using Zigbee® wireless technology produced by Phillips Electronics Co. of New York, N.Y.

In an alternative embodiment, the wireless network bridge of the present invention is portable and removably attached to vehicle 20. In this alternative embodiment, antenna assembly 12, signal indicator 14, and hub 16 are located within a central housing that may be attached to a windshield by a suction cup similar to the way a radar detector is attached to a windshield. In this alternative embodiment, antenna assembly 12 is located within vehicle 20 and the entire wireless network bridge can be plugged into a traditional power outlet located in a vehicle. This alternative embodiment is advantageous because it enables the wireless network bridge to be easily transported from one vehicle 20 to another by simply unplugging the device from the power outlet.

Additionally, it should also be noted that while providing internet access to a single computer 18 is disclosed herein, that internet access can be provided to a network of several computers within a vehicle and fall within the scope of the present invention. Finally, although specific brand named components from certain manufacturers are discussed herein, any similar components can be used and fall within the scope of the present invention.

In use, the user would be alerted to the presence and strength of a particular hot spot by observing the signal indicator as he was riding in a vehicle such as a taxi or RV. Once a hot spot is detected, the user can immediately begin surfing the internet and sending and receiving e-mail. During internet use, the user can monitor the strength of the hot spot by observing the signal indicator and decide whether to stop the vehicle to stay within a particular hot spot or to move forward if the signal indicator showed that another hot spot was available when the vehicle was reaching the outskirts of the range of the first hot spot. If the user continually remained in the presence of a hot spot, his internet access would be continuously available.

While the term Wi-Fi is used throughout, any type of high-speed, wireless internet communication protocol falls within the scope of the present invention. Additionally, although the term “Ethernet” is used throughout to identify the protocol used to deliver the wireless internet data across the network, any network protocol falls within the scope of the present invention.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A device for enabling a computer within a vehicle to transmit and receive data over a wireless network comprising:
a) an antenna located outside the vehicle that receives and transmits the data to and from an access point;
b) a signal indicator that monitors the strength of an internet access signal; and
c) a power source to provide power to the signal indicator and the antenna.

2. The device according to claim 1 wherein the wireless network uses a wi-fi network standard.

3. The device according to claim 1 wherein the data relates to the internet and enables a user to receive internet protocol communications while the vehicle is moving.

4. The device according to claim 3 wherein the user can send and receive data over the internet when the vehicle is over a thousand feet away from the access point.

5. The device according to claim 1 wherein the antenna broadcasts the strength of the internet signal using variable frequency modulation which is transmitted to the signal indicator.

6. The device according to claim 5 wherein the signal indicator receives the variable frequency modulation data and provides an indication of the strength of the internet access signal.

7. The device according to claim 1 wherein the antenna passes data received from the access point to a computer using Ethernet protocol.

8. The device according to claim 1 wherein the data is transmitted on a 802.11 standard protocol.

9. The device according to claim 1 wherein the signal indicator is permanently attached to the vehicle on a dashboard.

10. A device for enabling a computer located in a moving vehicle to transmit and receive data over the internet comprising:
a) an antenna attached to the exterior of the vehicle that transmits and receives data from an access point;
b) a signal indicator located within the vehicle that provides a visual or audible indication of the strength of the signal being sent from the access point; and
c) a hub that transmits the data received from the antenna to a computer.

11. The device according to claim 10 wherein the antenna, signal indicator, and hub are permanently attached to the vehicle.

12. The device according to claim 11 wherein the signal indicator is attached to a dashboard.

13. The device according to claim 10 wherein the antenna, signal indicator, and hub are removably affixed to the vehicle.

14. The device according to claim 10 wherein the antenna is a high gain antenna and is capable of receiving data from the access point when the antenna is over two thousand feet away from the access point.

15. A method of obtaining internet access while in a moving vehicle comprising:
a) providing a system comprising:
i) an antenna attached to the exterior of a vehicle that transmits and receives data from an access point;
ii) a signal indicator located within the vehicle that provides a visual or audible indication of the strength of the signal being sent from the access point; and
ii) a power source that powers the signal indicator and antenna while also passing the data received from the antenna to a computer;
b) providing a first stationary access point that transmits and receives wireless signal within a certain range;
c) attaching a computer to the hub;
d) moving the vehicle to a position where the antenna is close enough to the access point to receive and transmit data to and from the first stationary access point;
e) confirming that the vehicle is close enough to the first stationary access point to connect to the internet by monitoring the signal provided by the signal indicator; and
f) connecting the computer to the internet and transmitting data over the internet by transferring data between the antenna and the first stationary access point.

16. The method according to claim 15 further comprising a second stationary access point that transmits and receives wireless signal in a different geographical location than the first stationary access point.

17. The method according to claim 16 further comprising moving the vehicle out of the geographical range of the first stationary access point and into the geographical range of the second stationary access point so that the antenna receives data from the second stationary access point and not the first stationary access point.

18. The method according to claim 17 further comprising transmitting and receiving data to and from the second stationary access point.

19. The method according to claim 15 wherein the vehicle is a recreational vehicle.

20. The method according to claim 15 wherein the vehicle is a boat.
